(19) United States
(12) Patent Application Publication
(10) Pub. No.: US 2008/0278961 A1
(43) Pub. Date: Nov. 13, 2008

(54) Hybrid Optics for L.E.D. Lamp

(76) Inventor: Cole J. Cunnien, Canton, MI (US)

Correspondence Address: MAGNA INTERNATIONAL, INC., 337 MAGNA DRIVE, AURORA, ON, L4G-7K1, CA

(21) Appl. No.: 11/719,544

(22) PCT Filed: Nov. 30, 2005
(86) PCT No.: PCT/US2005/043133

§ 371 Date: May 17, 2007

Related U.S. Application Data
(60) Provisional application No. 60/631,840, filed on Nov. 30, 2004.

(51) Int. Cl. F21V 7/00

(52) U.S. Cl. 362/516

(57) ABSTRACT

A lighting assembly is adapted to be fixedly secured to a motor vehicle for emitting light out therefrom. The lighting assembly includes a frame for supporting and mounting the lighting assembly to the motor vehicle and a lens fixedly secured to the frame. The lighting assembly also includes a light emitting diode spaced from the lens for emitting light out through the lens. The lighting assembly further includes a reflector extending between the lens and the light emitting diode. The reflector includes a parabolic reflective surface, and a hyperbolic component for directing light emitted from the light emitting diode out toward the parabolic reflective surface at an angle such that the light passes through the lens as collimated light.

### BACKGROUND OF THE INVENTION

1. Field of the Invention

The invention relates to lighting assemblies for motor vehicles. More specifically, the invention relates to lighting assemblies for motor vehicles that emit light using a light emitting diode.

2. Description of the Related Art

Lighting assemblies for motor vehicles generally include lamps, reflective elements and lenses. The lamps emit light that is reflected off the reflective units and focused through the lenses. The lighting assemblies are used for purposes of visibility allowing an operator to see the roadway when ambient light is low. In addition, the light assemblies are used to signal to others outside the motor vehicle as to the direction and deceleration of the motor vehicle.

New technologies are allowing light emitting diodes (LEDs) to be used in place of incandescent and halogen lamps. The LEDs emit light in a manner very different from an incandescent lamp. The LEDs emit light in a single general direction with very little dispersion. Therefore, it is important that the light get dispersed sufficiently such that the lighting assembly is visible to others outside the motor vehicle in a more traditional manner. Some LEDs are manufactured with optical components fixedly secured thereto to help disperse the light in a manner suitable to be used in a lighting assembly. These LED optical component combinations are often referred to as “side emitting LEDs.” These side emitting LEDs are limited in the configuration of the lamp assembly based on the optical components that are attached to the LEDs. This makes it difficult to design unique lighting assembly structures that fit with the overall design of the motor vehicle. These types of LED/optical component combinations are typically only available as a high output, high cost product more suitable for low LED count solutions.

### SUMMARY OF THE INVENTION

According to one aspect of the invention, a lighting assembly is adapted to be fixedly secured to a motor vehicle for emitting light out therefrom. The lighting assembly includes a frame for supporting and mounting the lighting assembly to the motor vehicle and a lens fixedly secured to the frame. The lighting assembly also includes a light emitting diode spaced from the lens for emitting light out through the lens. The lighting assembly further includes a reflector extending between the lens and the light emitting diode. The reflector includes a parabolic reflective surface, and a hyperbolic component for directing light emitted from the light emitting diode out toward the parabolic reflective surface at an angle such that the light passes through the lens as collimated light.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a fragmentary, perspective view of a motor vehicle incorporating a lighting assembly according to the invention;

FIG. 2 is an enlarged perspective view of the lighting assembly;

FIG. 3 is a cross-sectional view taken along lines 3-3 of FIG. 1 with rays of light schematically drawn;

FIG. 4 is an enlarged view of FIG. 3 with rays of light schematically drawn;

FIG. 5 is a fragmentary, enlarged view of FIG. 3 with rays of light schematically drawn; and

FIG. 6 is a fragmentary, perspective view of an alternative embodiment of the invention.

### DETAILED DESCRIPTION OF THE PREFERRED EMBODIMENTS

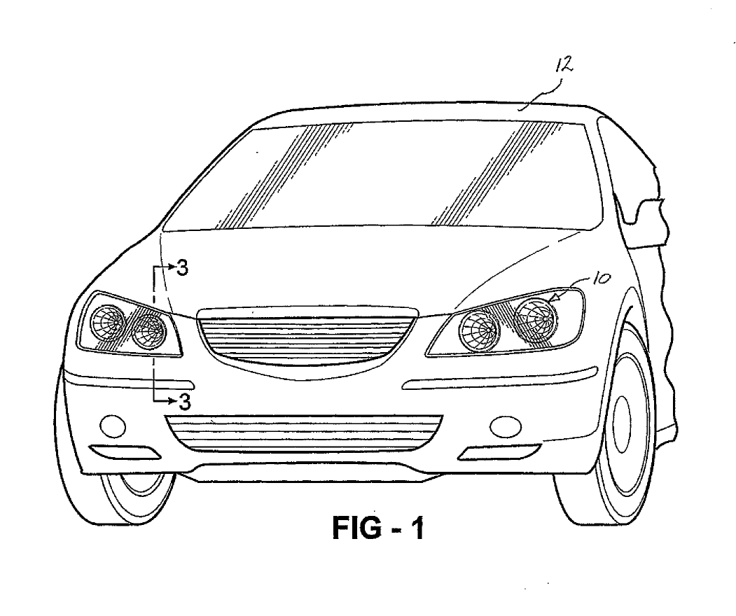

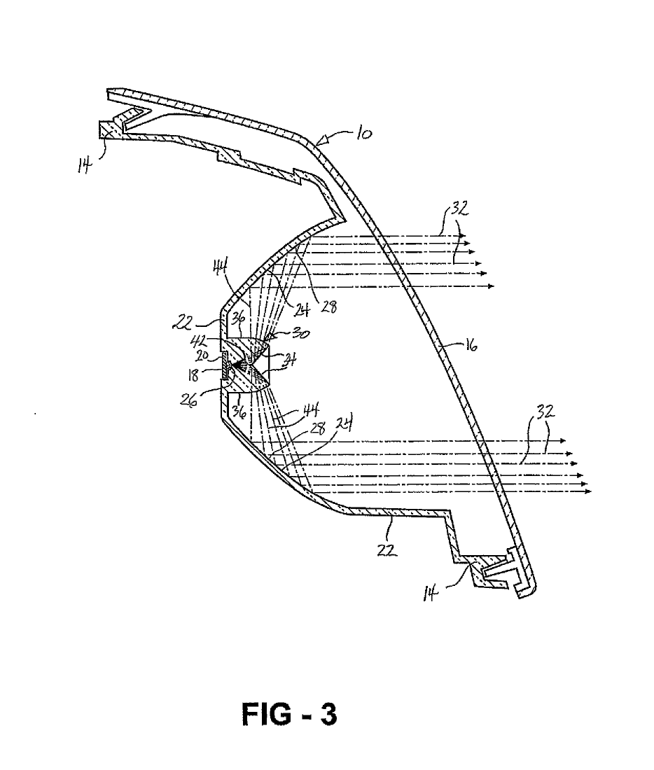

Referring to FIG. 1, a lighting assembly is generally indicated at 10. The lighting assembly 10 is fixedly securable to a motor vehicle 12. The lighting assembly 10 emits light out therefrom. Referring now to FIG. 3, the lighting assembly includes a frame 14 that defines a periphery for the lighting assembly 10. The frame 14 may or may not extend around the entire periphery of the lighting assembly 10, but it is used to maintain the lighting assembly 10 in a predetermined position with respect to the motor vehicle 12.

The lighting assembly 10 includes a lens 16. The lens 16 is fixedly secured to the frame 14. Light emitted from the lighting assembly 10 is emitted through the lens 16. Typically, the lens 16 is substantially transparent. In some instances, the lens 16 may be translucent. In the instances where the lighting assembly 10 is used as a signaling device, the lens 16 may be colored red, yellow or white. In the case where the lighting assembly 10 is used by the operator of the motor vehicle 12 to aid the operator in the viewing of the road, the lens 16 is clear.

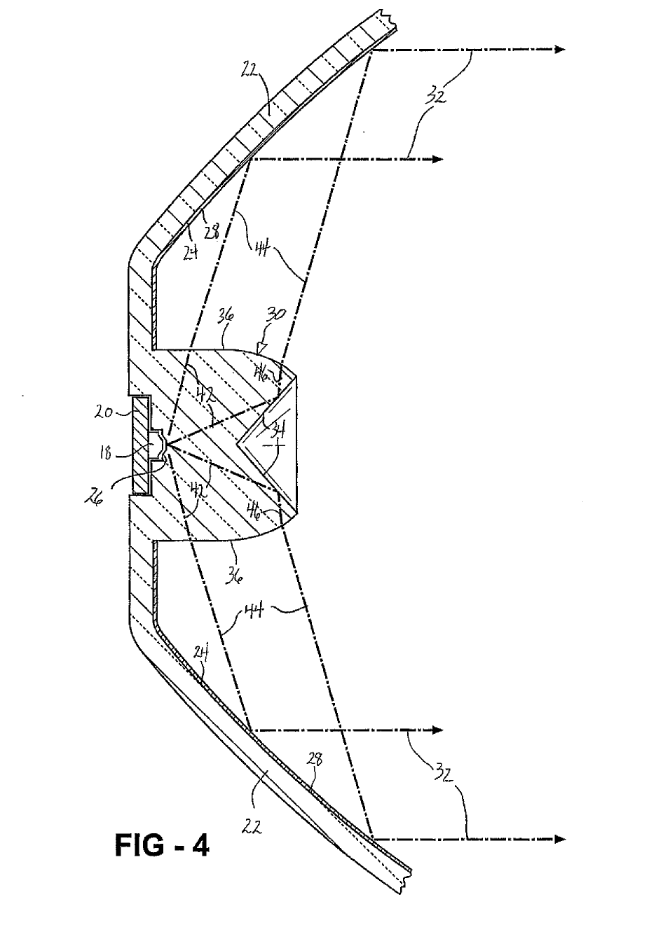

Referring to FIGS. 3 and 4, the lighting assembly 10 also includes a light emitting diode (LED) 18 that is spaced from the lens 16 for emitting light through the lens 16. The LED 18 emits light in a single general direction that is conical in shape. More specifically, the LED 18 emits light out therefrom at an angle in every direction rendering portions of the area surrounding the LED 18 not awash in light emitted thereby. Typically, the LED 18 is mounted to a circuit board 20, the LED 18 and circuit board 20 defining a single package.

The lighting assembly 10 also includes a reflector 22 that extends between the lens 16 and the LED 18. The reflector 22 includes a parabolic reflective surface 24 surrounding a port 26 for receiving light emitted from the LED 18. The reflector 22 is substantially transparent allowing light from the LED 18 to pass through the port 26. The parabolic reflective surface 24 directs the light that impinges thereupon in a direction toward the lens 16. Typically, the parabolic reflective surface 24 has a metalized coating 28 to maximize the efficiency of the reflective properties of the parabolic reflective surface 24.

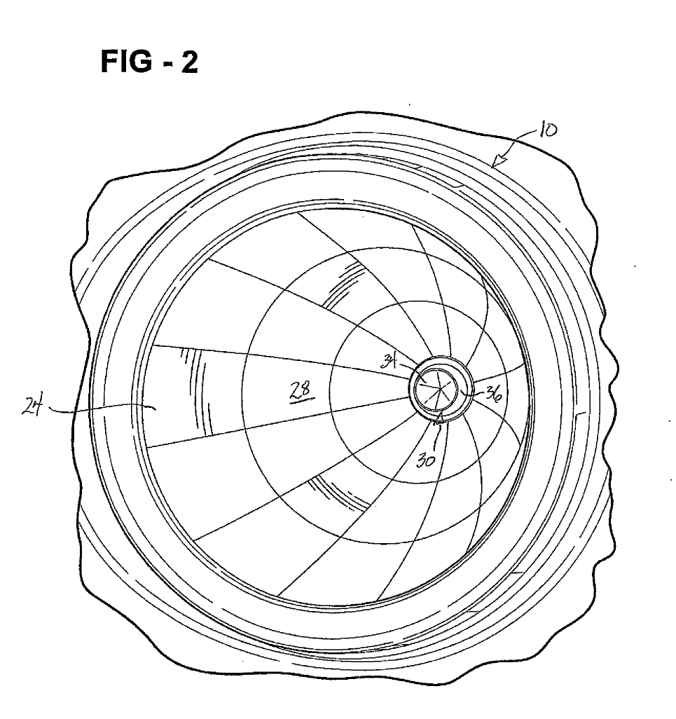

Referring to FIGS. 2 through 4, the reflector 22 also includes a hyperbolic component, generally indicated at 30. The hyperbolic component 30 is substantially transparent, directing light emitted from the LED 18 out toward the parabolic reflective surface 24 at an angle such that light passing through the lens 16 is collimated light 32. The hyperbolic component 30 is shown having a hyperbolic surface 34 and a refraction surface 36. The hyperbolic surface 34 utilizes total internal reflection. The hyperbolic surface 34 may be metalized similar to the parabolic reflective surface 24. This aids in reflecting light that would otherwise not be reflected by the hyperbolic surface 34 due to minor manufacturing variations in the hyperbolic surface 34.

Much of the light that is emitted from the LED 18 through the port 26 is received by the hyperbolic component 30 such that light is refracted according to the design of the hyperbolic component 30. More specifically, the light emitted from the LED 18 through the port 26 is refracted through the refraction surface 36 toward the parabolic reflective surface 24 and out through the lens 16 as collimated light 32. Should some light emitted from the LED 18 obviate the refractive qualities of the hyperbolic component 30, the hyperbolic surface 34 will reflect that light toward the refraction surface 36 to maximize the efficiency of the lighting assembly 10 by directing all of the light emitted from the LED 18 to the parabolic reflective surface 24 and out through the lens 16 as collimated light 32.

In the preferred embodiment, the reflector 22 is a reflecting article that is fabricated to include the parabolic reflective surface 24 and the hyperbolic component 30 as a single, substantially transparent unit. It is important to be able to design the hyperbolic component 30 and the parabolic reflective surface 24 as a single unit to maximize the ability to design reflectors 22 and lighting assemblies 10. In this manner, the hyperbolic component 30 and parabolic reflective surface 24 may not be mathematically pure: they are designed to maximize the direction of light based on the aesthetic design of the lighting assembly 10. More specifically, by incorporating the design of the hyperbolic component 30 with the parabolic reflective surface 24, the configuration and profile of the lighting assembly 10 is not limited to the design parameters of those entities that merely create the LED 18. The creation of a reflector 22 having both the parabolic reflective surface 24 and the hyperbolic component 30 also reduces requirements for inventory and alignment procedures to ensure the maximization of the efficiency of the lighting assembly 10. In addition, the cost of the lighting assembly 10 and the labor involved in assembling the lighting assembly 10 are reduced.

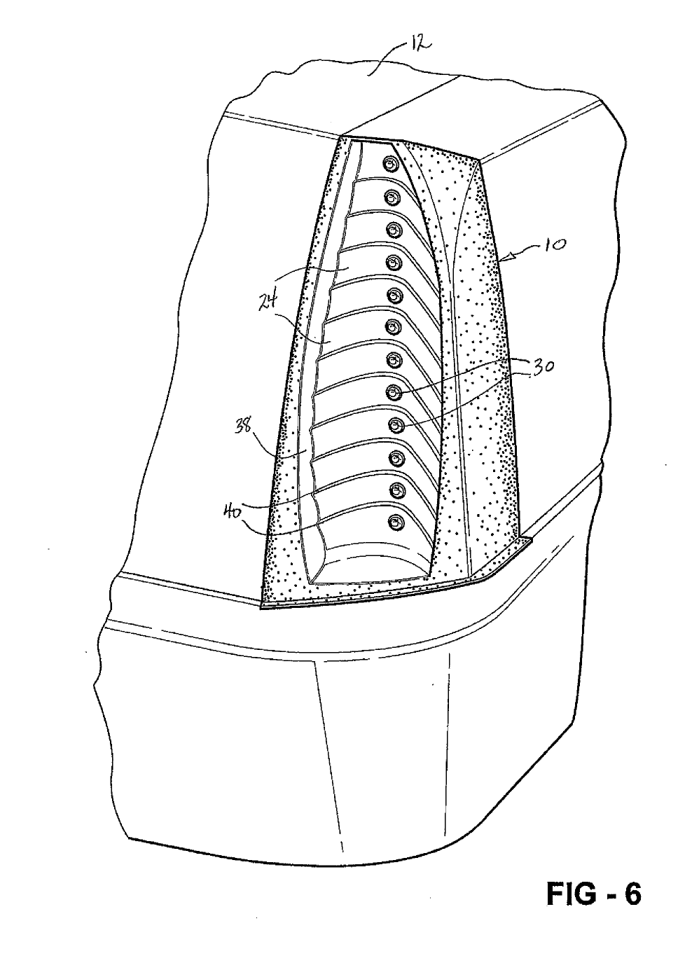

In an alternative embodiment, as shown in FIG. 6, the lighting assembly 10 may include a plurality of parabolic reflective surfaces 24 and hyperbolic components 30. The plurality of parabolic reflective surfaces 24 and hyperbolic components 30 is used to define an overall reflective surface 38 of the lighting assembly 10. It should be appreciated by those skilled in the art that the overall reflective surface 38 is shaped and designed for a particular lighting assembly 10 that is designed for a particular motor vehicle design. Many overall reflective surfaces 38 are possible and any number of parabolic reflective surfaces 24 and hyperbolic components 30 may be used to create the overall reflective surface 38. It should also be appreciated that edges 40 of the parabolic reflective surfaces 24 do not have to be parallel as they are shown in FIG. 6.

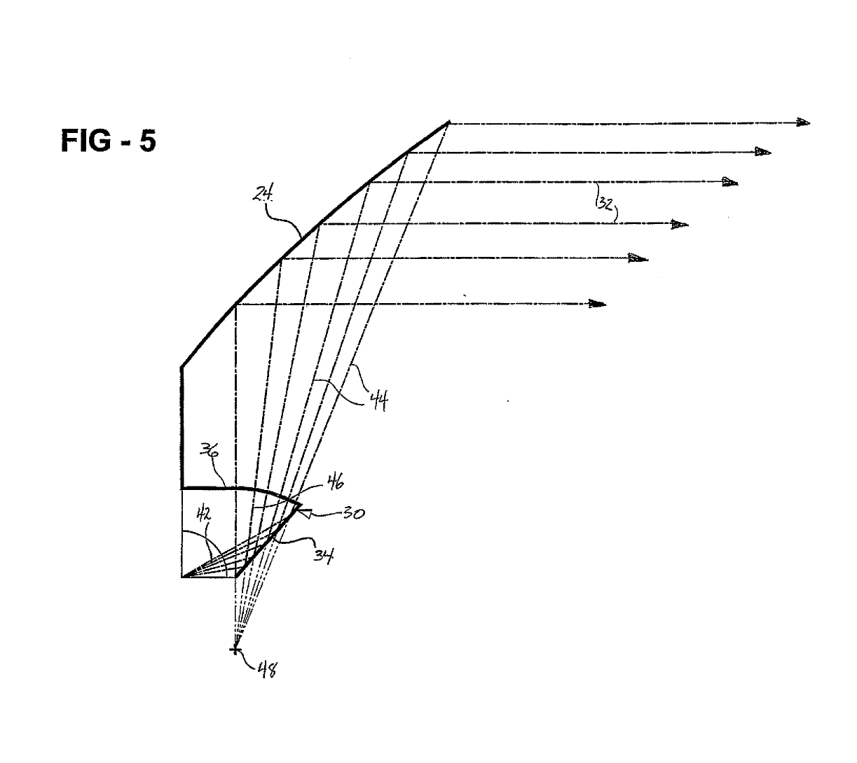

Referring to FIGS. 3, 4 and 5, examples of rays of light 42 emitted by the LED 18 are shown. The rays of light 42 emitted from the LED 18 pass through the port 26 and into the hyperbolic component 30. The rays of light 42 are either refracted by the refraction surface 36 in a direction indicated by the refracted rays of light 44 or are reflected by the hyperbolic surface 34 in a direction indicated by the reflected rays of light 46. The reflected rays of light 46 are then refracted as they pass through the refraction surface 36. The refracted rays of light 44 impinge upon the metalized coating 28 on the parabolic reflective surface 24 and are reflected out to create collimated light 32. FIG. 5 also shows a phantom focal point 48 of the LED 18 based on the properties of the refracted rays of light 44 as if the hyperbolic component 30 was not in the path through which the rays of light 42 travel. The reflection and refraction of the rays of light allows for a more compact and efficient lighting assembly 10 by obviating the requirement of having the LED 18 located at the phantom focal point 48.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A lighting assembly adapted to be fixedly secured to a motor vehicle for emitting light out therefrom, said lighting assembly comprising:
a frame for supporting and mounting said lighting assembly to the motor vehicle;
a lens fixedly secured to said frame;
a light emitting diode spaced from said lens for emitting light out through said lens; and
a reflector extending between said lens and said light emitting diode, said reflector including a parabolic reflective surface, and a hyperbolic component for directing light emitted from said light emitting diode out toward said parabolic reflective surface at an angle such that the light passes through said lens as collimated light.

2. A lighting assembly as set forth in claim 1 wherein said hyperbolic component includes a hyperbolic surface for reflecting light emitted from said light emitting diode and a refraction surface for refracting light emitted from said light emitting diode and reflected by said hyperbolic surface.

3. A lighting assembly as set forth in claim 2 wherein said reflector includes a port for receiving light emitted from said light emitting diode.

4. A lighting assembly as set forth in claim 3 including a metalized coating covering said parabolic reflective surface.

5. A lighting assembly as set forth in claim 4 including a metalized coating covering said hyperbolic surface of said hyperbolic component.

6. A lighting assembly as set forth in claim 5 wherein said lighting assembly includes a plurality of said parabolic reflective surfaces and a plurality of said hyperbolic components.

7. A reflecting article adapted to be fixedly secured to a motor vehicle to direct light emitted from a light emitting diode through a lens, said reflecting article including a port for receiving the light, a hyperbolic surface for reflecting the light, a refraction surface for refracting the light to create refracted light, and a parabolic reflector extending out from said refraction surface to reflect the refracted light into collimated light.
